(19) United States
(12) Patent Application Publication
(10) Pub. No.: US 2024/0361797 A1
(43) Pub. Date: Oct. 31, 2024

(54) Special-Purpose Compute Hardware for Efficient Implementation of Programmable Look-Up-Tables

(71) Applicant: International Business Machines Corporation, Armonk, NY (US)

(72) Inventors: Geoffrey Burr, Cupertino, CA (US); Milos Stanisavljevic, Langnau am Albis (CH); Yasuteru Kohda, Yamato-shi (JP)

(21) Appl. No.: 18/140,107

(22) Filed: Apr. 27, 2023

(51) Int. Cl. G06F 1/03; G06F 7/544; G06N 3/048

(52) U.S. Cl. CPC G06F 1/03; G06F 7/5443; G06N 3/048

(57) ABSTRACT

Special-purpose digital-compute hardware for fully-programmable look-up-tables is provided. In one aspect, a system for implementing a continuous function by piecewise linear approximation includes: at least one memory programmatically loaded with an indexed table of slope/intercept values of linear segments along a gradient of the continuous function approximating a plurality of contiguous ranges of the continuous function; at least one Bin ID logic having data registers programmatically loaded with bin-threshold values corresponding to the plurality of contiguous ranges defining a series of arbitrarily-spaced bins; and a Fused-Multiply-Add circuit configured to multiply an incoming data element by a slope value and add an intercept value from the indexed table of slope/intercept values selected based on the bin-threshold values. Comparators in the Bin ID logic can be configured to compare the incoming data-element with the bin-threshold values. A method for implementing a continuous function by piecewise linear approximation is also provided.

### FIELD OF THE INVENTION

The present invention relates to look-up-table technology, and more particularly, to special-purpose digital-compute hardware and use thereof for providing fully-programmable look-up-tables for implementations such as piecewise linear approximation.

### BACKGROUND OF THE INVENTION

Many neural network activation functions such as tanh and sigmoid functions are continuous, nonlinear functions, i.e., y=ƒ(x), which are amenable to implementation by piecewise linear approximation. With piecewise linear approximation, the nonlinear function is approximated using a series of linear segments that follow the gradient of the function. Each linear segment is defined by its slope and vertical/y-axis intercept.

Efficient piecewise linear approximation performance can be realized using a look-up-table approach to facilitate retrieval of the slope and intercept values. A look-up-table (often abbreviated as LUT) is a data array that replaces runtime computation with a simple table indexing operation. For a given input value, a look-up-table operation can involve retrieving a corresponding slope and intercept as output values from the look-up-table, followed by a multiplication between the slope and the input value, followed by addition of the intercept value, thereby approximating the original complicated function with a straightforward multiply-and-add operation.

Conventional look-up-table approaches to piecewise linear approximation typically have the slope and intercept values hard-coded into the system. As such, the look-up-table is fixed at design time. While this is done for compact implementation, a flexible solution is needed that can accommodate different values at test-time.

### SUMMARY OF THE INVENTION

The present invention provides special-purpose digital-compute hardware and use thereof for providing fully-programmable look-up-tables for implementations such as piecewise linear approximation. In one aspect of the invention, a system for implementing a continuous function by piecewise linear approximation is provided. The system includes: at least one memory (e.g., a static random access memory) that is programmatically loaded with an indexed table of slope and intercept values, where each of the slope and intercept values corresponds to a linear segment along a gradient of the continuous function that approximates one of a plurality of contiguous ranges of the continuous function; at least one Bin ID logic having data registers that are programmatically loaded with bin-threshold values corresponding to boundaries of each of the plurality of contiguous ranges, thereby defining a series of arbitrarily-spaced bins; and a Fused-Multiply-Add circuit configured to multiply an incoming data element by a slope value and add an intercept value from the indexed table of slope and intercept values in the memory in order to implement a programmed look-up-table implementation of the continuous function, where the slope value and the intercept value correspond to which of the plurality of contiguous ranges the incoming data-element belongs in based on the bin-threshold values in the data registers of the Bin ID logic.

Advantageously, the programmable data registers in the at least one Bin ID logic enable the system to handle arbitrarily-spaced bins, such as when the series of arbitrarily-spaced bins includes unevenly-spaced bins. As a result, with arbitrary bin spacing, the maximum number N of bins does not have to be a power of 2, and a range can be used that is arbitrarily arranged with respect to X=0.0.

In another aspect of the invention, another system for implementing a continuous function by piecewise linear approximation is provided. The system includes: at least one memory that is programmatically loaded with an indexed table of slope and intercept values, where each of the slope and intercept values corresponds to a linear segment along a gradient of the continuous function that approximates one of a plurality of contiguous ranges of the continuous function; at least one Bin ID logic having data registers that are programmatically loaded with bin-threshold values corresponding to boundaries of each of the plurality of contiguous ranges thereby defining a series of arbitrarily-spaced bins, and comparators configured to compare at least one incoming data-element with the bin-threshold values in the data registers of the Bin ID logic; and a Fused-Multiply-Add circuit configured to multiply the at least one incoming data element by a slope value and add an intercept value from the indexed table of slope and intercept values in the memory in order to implement a programmed look-up-table implementation of the continuous function, where the slope value and the intercept value correspond to which of the plurality of contiguous ranges the at least one incoming data-element belongs in based on the bin-threshold values in the data registers of the Bin ID logic.

Advantageously, the operations can be performed with 16-bit floating-point arithmetic. For instance, embodiments are contemplated herein where the at least one incoming data-element includes a pair of 16 bit floating-point (FP16) data-elements, and a multiplexer of the system is configured to choose this pair of FP16 data-elements from four FP16 data-elements that arrive at the system in each clock cycle. The comparators are then configured to compare the pair of FP16 data-elements with the bin-threshold values in the data registers of the Bin ID logic in parallel.

In yet another aspect of the invention, a method for implementing a continuous function by piecewise linear approximation is provided. The method includes: programmatically loading an indexed table of slope and intercept values in a memory, where each of the slope and intercept values corresponds to a linear segment along a gradient of the continuous function that approximates one of a plurality of contiguous ranges of the continuous function; programmatically loading data registers of a Bin ID logic with bin-threshold values corresponding to boundaries of each of the plurality of contiguous ranges, thereby defining a series of arbitrarily-spaced bins; identifying in which of the plurality of contiguous ranges an incoming data-element belongs based on the bin-threshold values in the data registers of the Bin ID logic using a bin-index; using the bin-index to retrieve a corresponding slope value and a corresponding intercept value from the indexed table of slope and intercept values in the memory; and multiplying the incoming data-element by the corresponding slope value and adding the corresponding intercept value in order to implement a programmed look-up-table implementation of the continuous function.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary programmable look-up-table system for according to an embodiment of the present invention;

FIG. 3 is a diagram illustrating an exemplary neural network according to an embodiment of the present invention;

FIG. 4 is a diagram illustrating an exemplary methodology for implementing a continuous function by piecewise linear approximation according to an embodiment of the present invention;

FIG. 5 is a diagram illustrating an exemplary implementation of the methodology of FIG. 4 using the programmable look-up-table system of FIG. 2 for piecewise linear approximation of a continuous function according to an embodiment of the present invention; and

FIG. 6 is a diagram illustrating an exemplary configuration of a Bin ID logic in the programmable look-up-table system of FIG. 2 according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

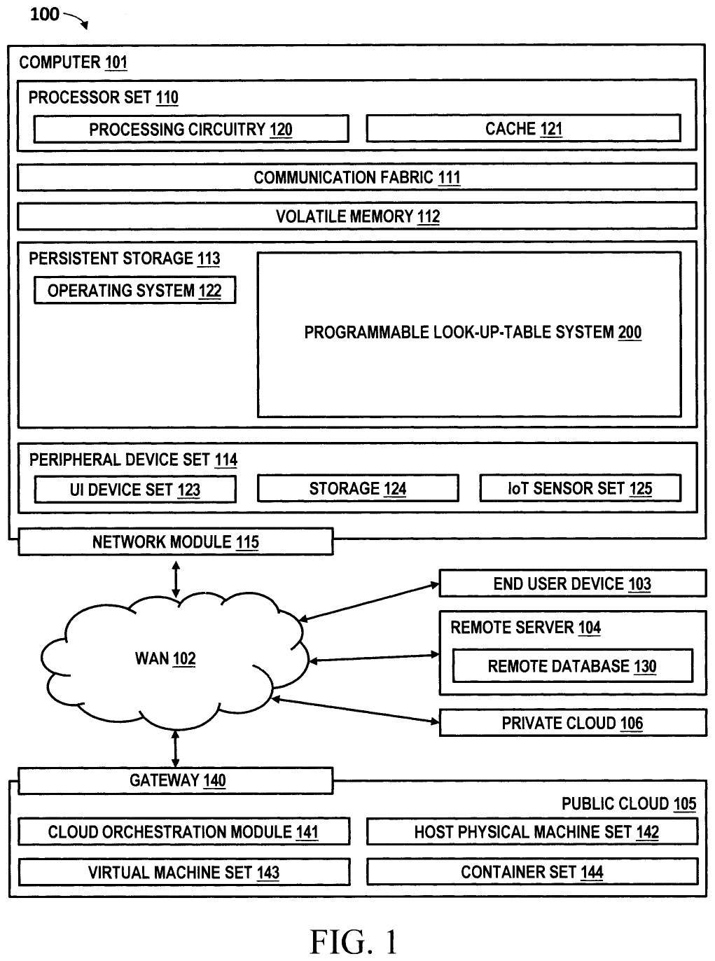

Referring to FIG. 1, computing environment 100 contains an example of an environment for the execution of at least some of the computer code involved in performing the inventive methods, such as programmable look-up-table system 200 for implementations such as piecewise linear approximation (see below). In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

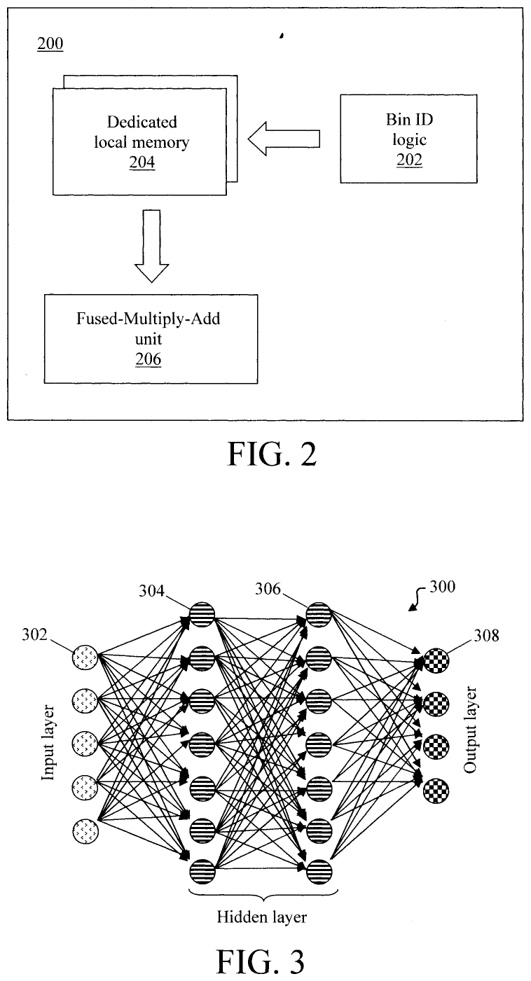

Referring to FIG. 2, an exemplary configuration of system 200 is provided. According to the exemplary embodiment shown in FIG. 2, system 200 includes a Bin ID logic 202, at least one dedicated local memory 204, and a Fused-Multiply-Add unit 206. In one exemplary embodiment, memory 204 is a volatile memory device such as static random access memory (SRAM). The Bin ID logic 202 includes a series of data registers containing bin-edge data that is used to identify (ID) to which bin an incoming data-element belongs. The output from the Bin ID logic 202 is used to select values for the identified bin that are stored within the memory 204. These selected values are then employed by the Fused-Multiply-Add unit 206 to perform fused multiply-add operations, i.e., operations where multiplication and addition are performed in one step.

As will be described in detail below, embodiments are contemplated herein where data-elements that arrive at the pipeline input to system 200 are handled in pairs (×2). Bin ID logic 202 compares each pair of incoming data-elements in parallel against the bin-edge data in the data registers, which is used to retrieve corresponding slope and intercept values from the memory 204. In some embodiments, each memory 204 (e.g., an SRAM) can read out the slope and intercept values for a data-element. Thus, multiple (in this case two) instances of memory 204 are provided to handle pairs of the data-elements at a given time-step.

According to an exemplary embodiment, system 200 is implemented in the piecewise linear approximation of a continuous function, i.e., y=ƒ(x), such as a neural network activation function. The activation function of a node in a neural network, such as neural network 300 of FIG. 3, defines the output of that node based on an input(s). As shown in FIG. 3, neural network 300 includes a plurality of interconnected nodes 302, 304/306 and 308 that form an input layer, at least one hidden layer, and an output layer, respectively, of the neural network 300. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer is a layer where all of the inputs from one layer are connected to every activation unit of the next layer. The fully connected layer(s) compile the data extracted by previous layers of the neural network to form the layer output, which in most cases becomes the input to the next layer of the neural network.

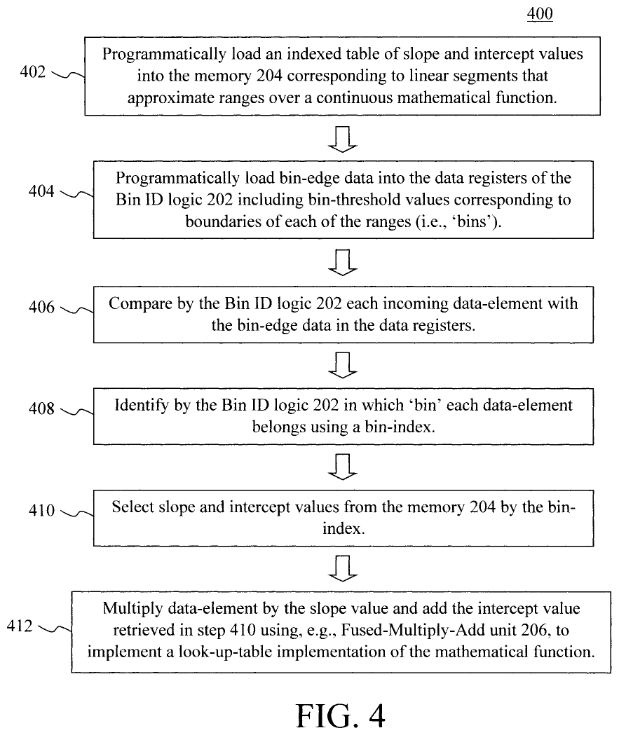

The piecewise linear approximation of a continuous mathematical function like a neural network activation function involves using a series of linear segments along the gradient of the function as an approximation of the function. As is generally known, this piecewise linear fitting of the function can be done by sampling points along the function, and then interpolating linearly between the points. Thus, each of these linear segments will have a slope and a vertical axis intercept (i.e., offset) which may also be referred to herein simply as the ‘intercept’. FIG. 4 provides an exemplary methodology 400 for implementing system 200 in this operation. In step 402, an indexed table of the slope and intercept values are first programmatically loaded into the memory 204. Notably, in accordance with the present techniques, the indexed table of the slope and intercept values is loaded into the memory 204 before operation, not calculated during operation. The same is true for the bin-edge data that is loaded into the data registers of the Bin ID logic 202 (see below) which is also done before operation, not calculated during operation. Each of the slope and intercept values corresponds to a linear segment that approximates a certain range of the function. As such, a plurality of the ranges combine contiguously to cover all relevant inputs to the function.

In step 404, the data registers of the Bin ID logic 202 are programmatically loaded with bin-edge data. According to an exemplary embodiment, the bin-edge data includes bin-threshold values that correspond to boundaries of each of the ranges. Namely, a data-element belongs to a particular bin N if its value is between the bin-threshold value of bin N and the preceding bin.

As will be described in detail below, an exemplary data pipeline through system 200 has (each) Bin ID logic 202 receiving a time-multiplexed sequence of input data-vectors, where each of the input data-vectors represents a plurality of individual data-elements encoded into floating point or integer format. Accordingly, in step 406 the Bin ID logic 202 then compares each incoming data-element Xₙ with the bin-edge data contained in its data registers. As will be described in detail below, in addition to the data registers, the Bin ID logic 202 circuitry also contains comparator circuits configured to compare the value of each incoming data-element with the bin-edge data programmatically loaded in the data registers.

Based on this comparison, in 408 the Bin ID logic 202 uses the bin-threshold values stored in the data registers which, as provided above, correspond to the boundaries of each of the ranges, to identify in which range of the function or ‘bin’ the incoming data-element belongs. Therefore, the bin-edge data defines a series of ‘bins.’ As will be described in detail below, these bins can be arbitrarily-spaced. The corresponding bin selected for the incoming data-element by the Bin ID logic 202 is identified using a bin-index. According to an exemplary embodiment, the bin-index is an address (i.e., indicating a specific location) in the memory 204.

Advantageously, the data registers of Bin ID logic 202 are fully-programmable. Notably, this means that the bins can be arbitrarily-spaced from one another, as long as the bins are filled with values that are arranged in order. Bin spacing is synonymous with bin width. As such, these terms may be used interchangeably herein. To look at it another way, the full programmability of system 200 enables each and every bin-threshold value to be specified uniquely without worrying about whether this results in the bins being evenly or unevenly spaced. Thus, embodiments are contemplated herein where the bin-edge data programmed in the data registers defines a series of unevenly-spaced bins. In general, the term ‘unevenly-spaced bins’ refers to a scenario where at least one of the bins is filled with a larger or smaller range of values over the function than at least another one of the bins. By comparison, ‘evenly-spaced bins’ denotes the situation where each of the bins is filled with a uniform range of values over the function. Thus, according to the present techniques, as long as the data registers of Bin ID logic 202 are filled with values that are arranged in order, e.g., monotonically, the spacings can be arbitrary. With arbitrary bin spacing, the maximum number N of bins does not have to be a power of 2, and a range can be used that is arbitrarily arranged with respect to X=0.0. Being able to implement arbitrarily-spaced bins has some notable advantages. For instance, if there is a section of the function where the derivative changes rapidly, causing sharp bends in the curve of the function, then smaller bins can be used at this spot. In other spots where the function is locally quite linear, larger bins can be employed. By contrast, if it is required that all of the bins be the same size, then many bins will be expended in the linear sections in order to get sufficient resolution for the sharp bends. In general, this tradeoff makes it difficult to accurately model sharp bends when one is constrained to a single bin-size. A similar argument follows for allocation of bins with respect to X=0.0.

Thus, what allows system 200 to handle arbitrary-spaced bins are the programmable data registers in the Bin ID logic 202, and whatever bin-edge data is programmatically loaded in the data registers is used to select the correct bin. For instance, by way of example only, if the maximum number N of bins is 64, then there can be a series of 63 data registers in the Bin ID logic 202 (e.g., one for the lower edge/threshold of each interior bin). Thus, the bins are also arranged in order from left to right. If the Bin ID logic 202 determines in step 408 that the incoming data-element Xₙ is between the 1^{st} and 2^{nd} data registers, then this data-element Xₙ value sits in Bin 1, e.g., the 2^{nd} Bin. Note that bin numbering often starts from 0. For instance, with pointer arithmetic, this particular part of memory starts at location M, and the first entry is at M+0. Then the second entry is at M+1, etc. This allows one to locally index the array from the main pointer and place the first element right at the location of the main pointer. In that case, the 2^{nd} slope and intercept values with address 1 (corresponding to Bin 1) will be retrieved from memory 204 in step 410 (see below). On the other hand, if the incoming data-element Xₙ is below the 1^{st} data register, then this data-element Xₙ value sits in the leftmost bin (which provides a slope and intercept that will work even for data-element values slightly outside of the range). This will produce an address 0, and the 1^{st} slope and intercept values with address 1 (corresponding to Bin 1) will be retrieved from memory 204 in step 410 (see below). Similarly, any incoming data-element Xₙ value beyond the 63^{rd} register gets an address of 63. Thus, in this example, there are addresses ranging from 0 through 63.

In step 410, the bin-index (address) assigned by the Bin ID logic 202 is used to retrieve the slope and intercept values stored in the corresponding row of the memory 204. As described in detail above, these slope and intercept values correspond to one of the linear segments that approximates one of a plurality of ranges or ‘bins’ of the function being implemented. Thus, the slope and intercept values retrieved from the memory 204 correspond to the bin selected by Bin ID logic 202. According to an exemplary embodiment, the Bin ID logic 202 is controlled by a computer processor such as that contained in the processor set 110 (see above). That computer processor is also connected to the memory 204, and thus can coordinate retrieval of the slope and intercept values from the memory 204 based on the bin-index assigned by the Bin ID logic 202. As such, the computer processor can be configured to perform the steps of methodology 400 in conjunction with the above-described components of system 200, i.e., the Bin ID logic 202, the memory 204, the Fused-Multiply-Add unit 206, etc.

In step 412, the incoming data-element is multiplied by the slope value and added to the intercept value (retrieved from the memory 204 in step 410), e.g., y=SLOPE*x+INTERCEPT, in order to implement a programmed look-up-table implementation of the mathematical function (e.g., the neural network activation function—see above). According to an exemplary embodiment, the multiplication and addition operations carried out in step 412 are performed in a single step using the Fused-Multiply-Add unit 206 which includes a standard Fused-Multiply-Add circuit for performing the operation A*B+C. Advantageously, conducting the multiplication and adding operations in a single step (e.g., via Fused-Multiply-Add unit 206) requires that only a single rounding operation be performed, rather than the two that would result from performing a multiply instruction followed by an add instruction.

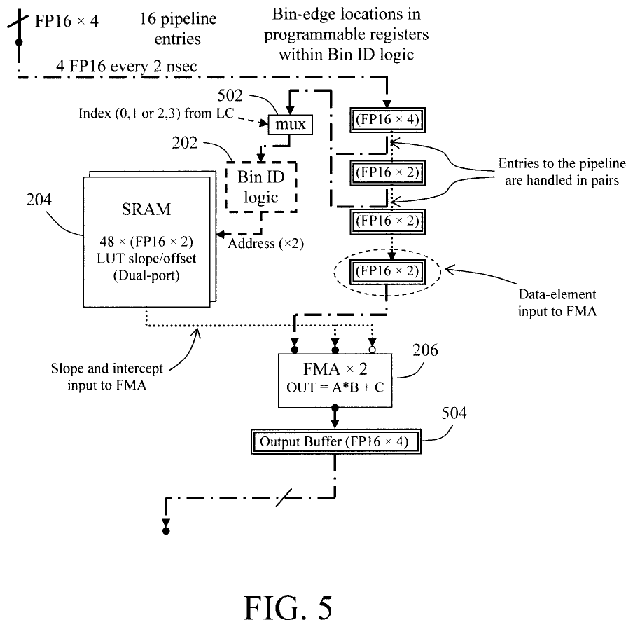

Given the above overview, an exemplary implementation of methodology 400 using the present programmable look-up-table system 200 for piecewise linear approximation of a continuous function is now described by way of reference to FIG. 5. In this example, operations are performed with 16 bit floating-point (FP16) arithmetic. Here, 64 entries are processed, time-multiplexed across 32 nanoseconds (ns) (or clock-cycles), in which 4 FP16 (labeled “FP16×4”) data-elements arrive at the pipeline input every 2 ns (at each clock-cycle). See FIG. 5.

As shown in FIG. 5, these 4 FP16 entries to the pipeline are handled in pairs (each labeled “FP16×2”). First, the 0 and 1 data-elements, i.e., data-elements X₀ and X₁, are injected into parallel Bin ID logic 202. A multiplexer (mux) 502 is used to choose a pair of X values, either data-elements X₀ and X₁ or data-elements X₂ and X₃ (see below), depending on the indexing from a local clock (LC). As described in conjunction with the description of step 402 and step 404 respectively of methodology 400 above, the memory 204 (in this case at least one dedicated local SRAM) is programmatically loaded with an indexed table of slope and intercept values that correspond to linear segments that approximate contiguous ranges over the continuous function, and the (in this case N FP16) data registers of the Bin ID logic 202 are programmatically loaded with bin-edge data including bin-threshold values corresponding to the boundaries of each of the ranges (i.e., bins) which can be arbitrarily spaced to include unevenly-spaced bins in some scenarios.

As described in conjunction with the description of step 406 of methodology 400 above, the Bin ID logic 202 then compares the data-elements X₀ and X₁ in parallel against the N FP16 data registers programmatically loaded with the bin-edge data. As will be shown and described in detail below, these programmable FP16 data registers are shared across the two parallel pipelines for efficiency. As described in conjunction with the description of step 408 of methodology 400 above, the output of the Bin ID logic 202 are bin-index values for the data-elements X₀ and X₁, in this case two independent address values representing the two Bin IDs for the X₀ and X₁ data-elements.

As described in conjunction with the description of step 410 of methodology 400 above, each address value is used to access one of the rows of the memory 204. According to an exemplary embodiment, each memory 204 can read out 2 FP16 data-elements, representing the appropriate slope and intercept values, which are passed to the (double-wide, i.e., FMA×2) Fused-Multiply-Add (FMA) unit 206. Thus, multiple (in this case two) instances of (SRAM) memory 204 are provided to handle pairs of the data-elements at a given time-step. Here, there are two factors of 2×. In each memory, 32 bits of memory are needed for each bin—16 bits for a slope and 16 bits for an intercept—which is one factor of 2×. Further, with two parallel memories, one can be reading say row M_0 of the first memory with the winning index for the first x_0, and then some different row M_1 for the winning index of the second input, x_1. So that is a second factor of 2×. By ‘double-wide’ it is meant that Fused-Multiply-Add (FMA) unit 206 can perform vectorized computations, i.e., where Fused-Multiply-Add (FMA) unit 206 has a vector-width of 2, and is able to handle A*X+C for two independent input terms X₀ and X₁ in parallel (compute parallelism). As described in conjunction with the description of step 410 of methodology 412 above, the Fused-Multiply-Add unit 206 then multiplies each data-element X₀ and X₁ (i.e., FP16×2—see FIG. 5) by the corresponding slope value and adds the corresponding intercept value, both retrieved from the memory 204, i.e., A*B+C, thus implementing a programmed look-up-table (LUT) implementation of the continuous function. Output from the Fused-Multiply-Add (FMA) unit 206 is placed in an output buffer 504. According to the exemplary embodiment depicted in FIG. 5, data is output from the Fused-Multiply-Add (FMA) unit 206 at the same rate at which it arrives, delayed by a pipeline delay dependent on the number of stages in the Bin ID logic 202, memory 204 access, and Fused-Multiply-Add (FMA) unit 206 operation. Advantages of having a dedicated memory 204, as opposed to a conventional cache memory tied to a microprocessor, include the ability to keep up with the pipelined logic, and reduced energy costs for repeated and predictable accesses to the dedicated memory.

On the next time-step of the pipeline, comparisons are initiated for the X₂ and X₃ data-elements from the initial four FP16 data-elements in parallel by the Bin ID logic 202. This is done in the same manner as described above. Namely, the Bin ID logic 202 compares the data-elements X₂ and X₃ in parallel against the N FP16 data registers which are shared across the two parallel pipelines and programmatically loaded with the bin-edge data for the arbitrarily-spaced bins. The output of the Bin ID logic 202 are bin-index values for the data-elements X₂ and X₃, in this case two independent address values representing the two Bin IDs for the X₂ and X₃ data-elements.

Each address value is then used to access one of the rows of the memory 204. In this exemplary embodiment, each memory 204 reads out 2 FP16 data-elements, representing the appropriate slope and intercept values, which are passed to the Fused-Multiply-Add (FMA) unit 206. Fused-Multiply-Add (FMA) unit 206 then multiplies each data-element X₂ and X₃ by the corresponding slope value and adds the corresponding intercept value, both retrieved from the memory 204, i.e., A*B+C, thus implementing a programmed look-up-table implementation of the continuous function.

As shown in FIG. 5, by appropriately organizing the pipeline and providing delay-lines for the original X₀, X₁ and X₂, X₃ input data, system 200 can fully consume 4 incoming data-elements for every 2 clock cycles. However, embodiments are also contemplated herein where larger implementations employ duplicate Bin ID logic 202 and memory 204 to provide, e.g., 4-way parallelism, allowing system 200 to consume 4 incoming data-elements for each clock cycle, rather than every 2 clock cycles.

Advantageously, the present look-up-table implementation is fully programmable by writing the bin-edge data into the data registers of Bin ID logic 202, and the slope and intercept values into the memory 204. This full programmability makes it possible to try out different look-up-table configurations during test time, to improve the piecewise linear approximation accuracy after fabrication, and to support a variety of different functions with the same system 200 hardware. While the example depicted in FIG. 5 supports up to 48 bins, as described above both larger and smaller implementations are contemplated herein.

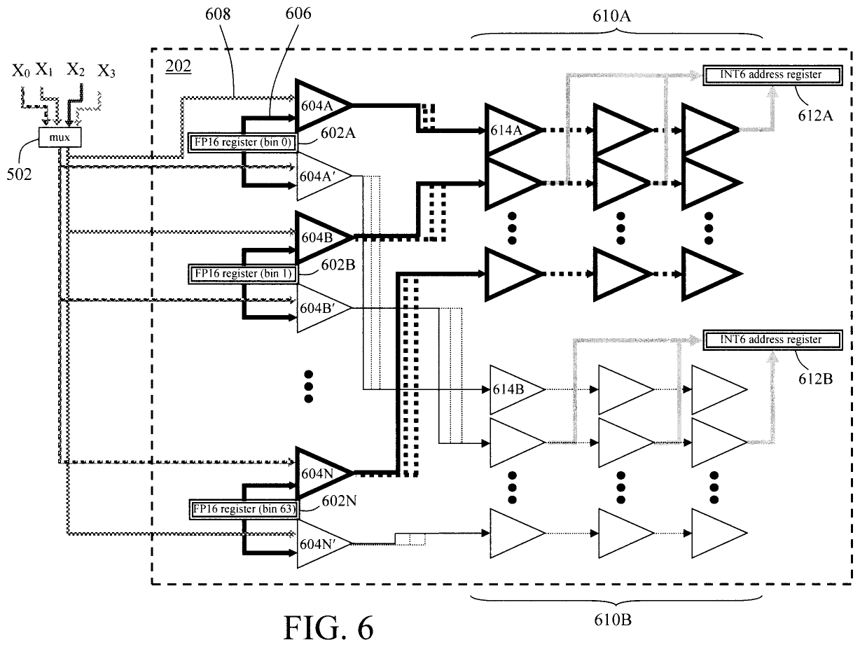

By way of example only, FIG. 6 is a diagram illustrating an exemplary configuration of the Bin ID logic 202. As described above, Bin ID logic 202 includes a series of data registers (see, e.g., data registers 602A, 602B, . . . , 602N) containing bin-edge data, in this case the bin-threshold values of bin 0, bin 1, . . . , bin 63, respectively. Further, as described above, the multiplexer (mux) 502 chooses a pair of incoming X values, either data-elements X₀ and X₁ or data-elements X₂ and X₃, which the Bin ID logic 202 processes in parallel.

Namely, Bin ID logic 202 first compares both data-elements X₀ and X₁ against the contents of each of the data registers 602A, 602B, . . . , 602N using a corresponding one of the comparators, e.g., comparators 604A/604A′, 604B/604B′, . . . , 604N/604N′, respectively. Namely, as shown in FIG. 6, comparator 604A is used to compare the bin-edge data in data register 602A (see arrow 606) against the incoming data-element X₁ (see arrow 608) and, in parallel, comparator 604A′ is used to compare the bin-edge data in data register 602A against the incoming data-element X₀. Likewise, comparator 604B is used to compare the bin-edge data in data register 602B against the incoming data-element X₁ and, in parallel, comparator 604B′ is used to compare the bin-edge data in data register 602B against the incoming data-element X₀, and so on.

This comparison process will produce a plurality of yes/no answers as to whether X₀ is higher or lower than the bin-threshold values stored in the data registers 602A, 602B, . . . , 602N, and similarly a plurality of yes/no answers applicable for X₁. Logic trees 610A and 610B are then used to turn those yes/no answers into the 6 bits of an address between 0 and 63 that, as described above, is used to access the slope and intercept values stored in a given row in the memory 204. The resulting addresses are stored in registers 612A and 612B, respectively. For instance, in the present example, logic tree 610A (having, e.g., logic gates 614A) is used to turn the yes/no answers corresponding to incoming data-element X₁ into a (6-bit) address that is stored in register 612A. Likewise, logic tree 610B (having, e.g., logic gates 614B) is used to turn the yes/no answers corresponding to incoming data-element X₀ into a (6-bit) address that is stored in register 612B.

Thus, some logic gates 614A/614B will have the job of producing bit 4, and others will produce bit 3, and so on. It is notable that, for ease and clarity of depiction, only one rank of logic gates 614A/614B is shown after the comparators 604A/604A′, 604B/604B′, . . . , 604N/604N′, in FIG. 6. However, more complex configurations may be implemented in accordance with the present techniques, such as those having a number of logic stages that combine results from the previous stage, or multi-input logic gates, e.g., an AND gate with 8-inputs that only produces a logic 1 if all eight inputs are 1.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A system for implementing a continuous function by piecewise linear approximation, the system comprising:
at least one memory that is programmatically loaded with an indexed table of slope and intercept values, wherein each of the slope and intercept values corresponds to a linear segment along a gradient of the continuous function that approximates one of a plurality of contiguous ranges of the continuous function;
at least one Bin ID logic comprising data registers that are programmatically loaded with bin-threshold values corresponding to boundaries of each of the plurality of contiguous ranges, thereby defining a series of arbitrarily-spaced bins; and
a Fused-Multiply-Add circuit configured to multiply an incoming data element by a slope value and add an intercept value from the indexed table of slope and intercept values in the memory in order to implement a programmed look-up-table implementation of the continuous function, wherein the slope value and the intercept value correspond to which of the plurality of contiguous ranges the incoming data-element belongs in based on the bin-threshold values in the data registers of the Bin ID logic.

2. The system of claim 1, wherein the continuous function comprises a neural network activation function.

3. The system of claim 1, wherein the memory comprises a dedicated local static random access memory.

4. The system of claim 1, wherein the series of arbitrarily-spaced bins comprise unevenly-spaced bins.

5. The system of claim 1, wherein the Fused-Multiply-Add circuit is configured to multiply the incoming data element by the slope value and add the intercept value with 16-bit floating-point arithmetic.

6. A system for implementing a continuous function by piecewise linear approximation, the system comprising:
at least one memory that is programmatically loaded with an indexed table of slope and intercept values, wherein each of the slope and intercept values corresponds to a linear segment along a gradient of the continuous function that approximates one of a plurality of contiguous ranges of the continuous function;
at least one Bin ID logic comprising data registers that are programmatically loaded with bin-threshold values corresponding to boundaries of each of the plurality of contiguous ranges thereby defining a series of arbitrarily-spaced bins, and comparators configured to compare at least one incoming data-element with the bin-threshold values in the data registers of the Bin ID logic; and
a Fused-Multiply-Add circuit configured to multiply the at least one incoming data element by a slope value and add an intercept value from the indexed table of slope and intercept values in the memory in order to implement a programmed look-up-table implementation of the continuous function, wherein the slope value and the intercept value correspond to which of the plurality of contiguous ranges the at least one incoming data-element belongs in based on the bin-threshold values in the data registers of the Bin ID logic.

7. The system of claim 6, wherein the at least one incoming data-element comprises a pair of 16 bit floating-point (FP16) data-elements.

8. The system of claim 7, further comprising:
a multiplexer configured to choose the pair of FP16 data-elements from four FP16 data-elements that arrive at the system in each clock cycle.

9. The system of claim 7, wherein the comparators are configured to compare the pair of FP16 data-elements with the bin-threshold values in the data registers of the Bin ID logic in parallel.

10. The system of claim 6, wherein the memory comprises a dedicated local static random access memory.

11. The system of claim 6, wherein the series of arbitrarily-spaced bins comprise unevenly-spaced bins.

12. A method for implementing a continuous function by piecewise linear approximation, the method comprising:
programmatically loading an indexed table of slope and intercept values in a memory, wherein each of the slope and intercept values corresponds to a linear segment along a gradient of the continuous function that approximates one of a plurality of contiguous ranges of the continuous function;
programmatically loading data registers of a Bin ID logic with bin-threshold values corresponding to boundaries of each of the plurality of contiguous ranges, thereby defining a series of arbitrarily-spaced bins;
identifying in which of the plurality of contiguous ranges an incoming data-element belongs based on the bin-threshold values in the data registers of the Bin ID logic using a bin-index;
using the bin-index to retrieve a corresponding slope value and a corresponding intercept value from the indexed table of slope and intercept values in the memory; and
multiplying the incoming data-element by the corresponding slope value and adding the corresponding intercept value in order to implement a programmed look-up-table implementation of the continuous function.

13. The method of claim 12, wherein the memory comprises a dedicated local static random access memory.

14. The method of claim 12, wherein the continuous function comprises a neural network activation function.

15. The method of claim 12, wherein the series of arbitrarily-spaced bins comprise unevenly-spaced bins.

16. The method of claim 12, further comprising:
comparing the incoming data-element with the bin-threshold values in the data registers of the Bin ID logic.

17. The method of claim 16, wherein the comparing is performed by comparators present in the Bin ID logic.

18. The method of claim 12, wherein the bin-index comprises an address in the memory.

19. The method of claim 12, wherein the multiplying and the adding are performed using a Fused-Multiply-Add circuit.

20. The method of claim 12, wherein the multiplying and the adding are performed with 16-bit floating-point arithmetic.
